(19) United States
(12) Patent Application Publication
(10) Pub. No.: US 2025/0240747 A1
(43) Pub. Date: Jul. 24, 2025

(54) INDICATION FOR PROPAGATION DELAY COMPENSATION

(71) Applicant: Telefonaktiebolaget LM Ericsson (PUBL), Stockholm (SE)

(72) Inventors: Zhenhua ZOU, Sollentuna (SE); John Walter DIACHINA, Garner, NC (US); Mattias BERGSTRÖM, Sollentuna (SE)

(21) Appl. No.: 18/700,768

(22) PCT Filed: Oct. 8, 2022
(86) PCT No.: PCT/EP2022/078002

§ 371 Date: Apr. 12, 2024

Related U.S. Application Data
(60) Provisional application No. 63/255,467, filed on Oct. 14, 2021.
(60) Provisional application No. 63/270,274, filed on Oct. 21, 2021.

(51) Int. Cl. H04W 56/00; H04W 48/10

(52) U.S. Cl. CPC H04W 56/0045; H04W 48/10

(57) ABSTRACT

A method by a user equipment, UE, for receiving reference time information includes receiving, from a network node, a dedicated message comprising first reference time information. The UE receives a first indication to acquire an alternative reference time information to the first reference time information in the dedicated message and applies a second reference time information received in a broadcast message.

### TECHNICAL FIELD

The present disclosure relates, in general, to wireless communications and, more particularly, systems and methods for indication for propagation delay compensation.

### BACKGROUND

In 3^{rd} Generation Partnership Project (3GPP) Release 16, 3GPP SA2 and RAN2 have aimed at providing support for Time Sensitive Networking (TSN) such that the 5th Generation System (5GS) can operate as a TSN logical bridge between TSN-based network elements. Successful 5G-TSN integration to support time critical industrial application requires end-to-end time synchronization. Time reference information such as that provided by, for example, a TSN Grandmaster Clock, is needed for the applications running on end devices in most of the industrial automation deployments. The same or an additional type of time reference information is also required in the bridges of a TSN network such as, for example, to realize an ingress to egress traffic delay target for a TSN bridge, when time-based TSN tools like Scheduled Traffic are used to provide deterministic low latency for time-critical traffic. See, Enhancements for Scheduled Traffic, IEEE 802.1Qbv-2015, www.ieee802.org/1/pages/802.1bv.-html, last visited Sep. 11, 2022.

Time synchronization requirements from vertical industries is defined by 3GPP TS 22.104 v18.2.0. Table 1 corresponds to Table 5.6.2-1 in 3GPP TS 22.104 v18.2.0 and shows a diverse set of clock synchronization service performance requirements for 5G system.

TABLE 1
Clock synchronization service performance requirements for 5G System

| | Number of | 5GS | | | | |
|---|---|---|---|---|---|---|
| User-specific | devices in one | synchronicity | | | | |
| clock | communication | budget | | | | |
| synchronicity | group for clock | requirement | | Service | | |
| accuracy level | synchronisation | (note 1) | | area | | Scenario |
| 1 | up to 300 UEs | ≤900 | ns | ≤100 m × 100 m | | Motion control |
| | | | | | | (A.2.2.1) |
| | | | | | | Control-to- |
| | | | | | | control |
| | | | | | | communication |
| | | | | | | for industrial |
| | | | | | | controller |
| | | | | | | (A.2.2.2) |
| 2 | up to 300 UEs | ≤900 | ns | ≤1,000 m × 100 m | | Control-to- |
| | | | | | | control |
| | | | | | | communication |
| | | | | | | for industrial |
| | | | | | | controller |
| | | | | | | (A.2.2.2) |
| 3 | up to 10 UEs | <10 | μs | ≤2,500 | m² | High data rate |
| | | | | | | video |
| | | | | | | streaming |
| 3a | up to 100 UEs | <1 | μs | ≤10 | km² | AVPROD |
| | | | | | | synchronisation |
| | | | | | | and packet |
| | | | | | | timing |
| 4 | up to 100 UEs | <1 | μs | <20 | km² | Smart Grid: |
| | | | | | | synchronicity |
| | | | | | | between PMUs |
| 4a | up to 100 UEs | <250 ns to 1 μs | | <20 | km² | Smart Grid: IEC |
| | | | | | | 61850-9-2 |
| | | | | | | Sampled |
| | | | | | | Values |
| 4b | up to 100 UEs | <10-20 | μs | <20 | km² | Smart Grid: IEC |
| | | | | | | 61850-9-2 |
| | | | | | | Sampled |
| | | | | | | Values - |
| | | | | | | Power system |
| | | | | | | protection in |
| | | | | | | digital |
| | | | | | | substation |
| 4c | 54/km² (note 2) | <10 | μs | several km² | | Smart Grid: |
| | 78/km² (note 3) | | | | | Intelligent |
| | | | | | | Distributed |
| | | | | | | Feeder |
| | | | | | | Automation |
| | | | | | | (A.4.4.3) |
| 4d | up to 100 UEs | <1 | ms | <20 | km² | Smart Grid: IEC |
| | | | | | | 61850-9-2 |
| | | | | | | Sampled |
| | | | | | | Values - Event |
| | | | | | | reporting and |
| | | | | | | Disturbance |
| | | | | | | recording |
| 5 | up to 10 UEs | <50 | μs | 400 | km | Telesurgery |
| | | | | | | (A.6.2) and |
| | | | | | | telediagnosis |
| | | | | | | (A.6.3) |

(note 1):
The clock synchronicity requirement refers to the clock synchronicity budget for the 5G system, as described in Clause 5.6.1.
(note 2):
When the distributed terminals are deployed along overhead line, about 54 terminals will be distributed along overhead lines in one square kilometre. The resulting power load density is 20 MW/km².
(note 3):
When the distributed terminals are deployed in power distribution cabinets, there are about 78 terminals in one square kilometre. The resulting power load density is 20 MW/km²,

For the integration with TSN, the 5GS is considered as a virtual bridge. For the time synchronization support, such a 5G virtual bridge is modelled as a time-aware system. See, Timing and Synchronization, IEEE 802.1AS, www.ieee802.org/1/-pages/802.las.html, last visited Sep. 11, 2022.

There are two synchronization processes running in parallel in an integrated 5G-TSN system. First, a 5G system internal synchronization process provides for the distribution of a 5G internal clock required to realize ingress to egress traffic delay targets for a 5GS. Second, a TSN synchronization process is run to realize synchronization between a TSN Grandmaster clock source and devices reachable through the 5GS.

The two synchronization processes can be considered independent from each other. The gNB only needs to be aware of and synchronized to the 5G reference clock as this is sufficient for the 5G system internal synchronization process to be kept intact, functioning and independent of TSN synchronization process (i.e. the external Generalized Precision Time Protocol (gPTP) synchronization process which makes use of gPTP Grand Master clocks delivered transparently through the 5G system).

The use of time synchronization has been common practice already for cellular networks of different generations and is an integral part of operating 5G cellular radio systems. The 5G radio network components themselves are also time synchronized such as for advanced radio transmission Examples of advanced radio transmission include synchronized Time Division Duplex (TDD) operation, cooperative multipoint (COMP) transmission, and carrier aggregation (CA). The new 5G capability introduced when integrating 5GSs and TSN networks is to provide 5G internal clock (reference time) delivery as a service over the 5GS. Once the 5G reference time is acquired by a gNodeB (gNB) such as, for example, from a GPS receiver, the 5G reference time is sent to different nodes in the 5G network with the goal of introducing as little synchronicity error and uncertainty as possible during distribution. Additionally, the distribution of 5G reference time information to UEs is designed to exploit the existing synchronized operation inherent to the 5G radio access network. Such a building block approach enables end-to-end time synchronization for industrial applications communication services running over 5G system.

The gNB maintains the acquired 5G reference time on an ongoing basis, as well as periodically projecting the value the gNB will have when a specific Antenna Reference Point (ARP) in the system frame structure occurs at the gNB. FIG. 1 illustrates gNB System Frame Number (SFN) transmissions where the ARP, which depicted as reference point tR, occurs at the end of SFN_{z}. Specifically, during SFNₓ, the gNB transmits a Radio Resource Control (RRC) broadcast message (e.g., a system information block (SIB)) or RRC unicast message, which contains the projected reference time value and the corresponding reference point (e.g., the value of SFN_{z}) during SFNₓ. For example, the projected reference time and corresponding reference point may be broadcast to all User Equipments (UEs) in SIB9. Alternatively, the projected reference time and corresponding reference point may be transmitted by unicast to an individual UE in a DLInformationTransfer RRC message. The information is received by a UE in advance of t_{R}.

The message used to send the 5G reference time information may also contain an uncertainty value to indicate to the UE the expected error that the indicated 5G reference time value (applicable to the reference point tR₎ is expected to have. The uncertainty value reflects (a) the accuracy with which a gNB implementation can ensure that the indicated reference time corresponding to reference point t_{R} (the end of SFN_{z}) will reflect the actual time when that reference point occurs at the ARP and (b) the accuracy with which the reference time can be acquired by the gNB. The uncertainty introduced by (a) is implementation specific but is expected to be negligible and is therefore not further considered herein. The reference time information is transmitted in the RRC information element (IE) ReferenceTimeInfo. The details are shown below:

### Reference TimeInfo Information Element

| -- ASN1START | |
|---|---|
| -- TAG-REFERENCETIMEINFO-START | |
| ReferenceTimeInfo-r16 ::= SEQUENCE { | |
| time-r16 | ReferenceTime-r16, |
| uncertainty-r16 | INTEGER (0..32767) |
| OPTIONAL, -- Need S | |
| timeInfoType-r16 | ENUMERATED {localClock} |
| OPTIONAL, -- Need S | |
| referenceSFN-r16 | INTEGER (0..1023) |
| OPTIONAL -- Cond RefTime | |
| } | |
| ReferenceTime-r16 ::= | SEQUENCE { |
| refDays-r16 | INTEGER (0..72999), |
| refSeconds-r16 | INTEGER (0..86399), |
| refMilliseconds-r16 | INTEGER (0..999), |
| refTenNanoSeconds-r16 | INTEGER (0..99999) |

}
-- TAG-REFERENCETIMEINFO-STOP
-- ASN1STOP

ReferenceTimeInfo field descriptions

referenceSFN
This field indicates the reference SFN corresponding to the reference time
information. If referenceTimeInfo field is received in DLInformation Transfer
message, this field indicates the SFN of PCell.
time
This field indicates time reference with 10 ns granularity. The indicated time is
referenced at the network, i.e., without compensating for RF propagation
delay. The indicated time in 10 ns unit from the origin is
refDays*86400*1000*100000 + refSeconds*1000*100000 +
refMilliSeconds*100000 + refTenNanoSeconds. The refDays field specifies
the sequential number of days (with day count starting at 0) from the origin of
the time field.
If the referenceTimeInfo field is received in DLInformation Transfer message,
the time field indicates the time at the ending boundary of the system frame
indicated by referenceSFN. The UE considers this frame (indicated by
referenceSFN) to be the frame which is nearest to the frame where the
message is received (which can be either in the past or in the future).
If the referenceTimeInfo field is received in SIB9, the time field indicates the
time at the SFN boundary at or immediately after the ending boundary of the
SI-window in which SIB9 is transmitted.
If referenceTimeInfo field is received in SIB9, this field is excluded when
determining changes in system information, i.e. changes of time should
neither result in system information change notifications nor in a modification
of value Tag in SIB1.
timeInfoType
If timeInfoType is not included, the time indicates the GPS time and the
origin of the time field is 00:00:00 on Gregorian calendar date 6 Jan.
1980 (start of GPS time). If timeInfoType is set to localClock, the origin of the
time is unspecified.
uncertainty
This field indicates the uncertainty of the reference time information provided
by the time field. The uncertainty is 25 ns multiplied by this field. If this field is
absent, the uncertainty is unspecified.

In an industrial use case where the provision of industrial clock synchronization service is supported through the 5G system, the 5G system is, in practice, only allowed to contribute a portion of the maximum end-to-end synchronicity budget (uncertainty budget) allowed for any given TSN Grandmaster clock. There are many uncertainty components in the 5G system, including the UE internal synchronization error budget and the synchronization error budget associated with delivering the 5G internal clock to the user plane function (UPF) and the UE.

The biggest 5GS synchronization error introduced is when the 5G internal clock is delivered to a UE from the gNB via the Uu interface. It occurs on the air interface and is associated with the error due to unknown propagation delays. In some large cells, the propagation delay from the gNB to the UE can be as large as 1 us (i.e., the distance from the gNB to the UE is 300 meters). Without any propagation delay compensation applied to the 5G internal clock, it is not possible to meet some clock synchronization service performance requirements shown in the Table 1.

The range of uncertainty for the most demanding synchronization requirement for a single Uu interface shown in Table 2 below was agreed at 3GPP TSG-RAN WG2 #113-e to meet performance requirements in the Table 1. Two scenarios are listed to represent a general wide area deployment and a local deployment area.

TABLE 2
Time synchronization error budget for single Uu interface

| Scenario | Single Uu interface Budget |
|---|---|
| Control-to-Control | ±145 ns to ±275 ns |
| Smart Grid | ±795 ns to ±845 ns |

In 3GPP Rel-15/Rel-16, the legacy uplink (UL) transmission timing adjustment (i.e., Timing Advance (TA)) can be re-used to estimate and compensate the propagation delay. 3GPP TA command is utilized in cellular communication for UL transmission synchronization, and it is an implementation variant of a Round Trip Time (RTT) measurement. The dynamic part of the TA, i.e., N_{TA} is equal to (2 x propagation delay) considering the same propagation delay value applies to both DL and UL directions. Since the TA command is transmitted to the UE mainly via the Medium Access Control (MAC) control element (CE), the UE can derive the propagation delay. The challenges of the TA method are that it introduces up-to 540 ns uncertainty to determine the DL propagation delay on a single Uu interface. See, R1-1901470, Reply LS on TSN requirements evaluation, RAN1, 3GPP TSG-RAN WG1 Ad-Hoc Meeting 1901 Taipei, Taiwan, Jan. 21-25, 2019.

Thus, there is a need to introduce a new propagation delay compensation method to meet the most demanding synchronization requirement in Rel-17. The Rel-17 RAN work item “Enhanced Industrial Internet of Things (IoT) and ultra-reliable and low latency communication (URLLC) support for NR” has the following objective related with propagation delay compensation:

5. Enhancements for support of time synchronization:

| | |
|---|---|
| a. | RAN impacts of SA2 work on uplink time synchronization for TSN, if any. |
| | [RAN2] |
| b. | Propagation delay compensation enhancements (including mobility issues, if |
| | any). [RAN2, RAN1, RAN3, RAN4] |

In addition to enhancing the TA-based method with finer granularity TA commands and requirements, the other method is to leverage on the legacy multi-RTT positioning method. This legacy method makes use of, for example, the UE Receiver-Transmitter (Rx-Tx) time difference measurements and Downlink-Positioning Reference Signal-Received Power (DL-PRS-RSRP) of DL signals received from multiple Transmitter Reception Points (TRPs) measured by the UE, and the measured gNB Rx-Tx time difference measurements and Uplink-Sounding Reference Signal-Reference Signal Received Power (UL-SRS-RSRP) at multiple TRPs of UL signals transmitted from the UE. The measurements are used to determine the RTT at the positioning server which are used to estimate the location of the UE.

FIG. 2 illustrates RTT-based propagation delay compensation. The new RTT based delay compensation method leverages the legacy multi-RTT positioning method as follows:
a) UE transmits an uplink frame i and records the transmission time as t₁.
b) gNB receives uplink frame i and records the time of arrival of the first detected path as t₃.
c) gNB transmits a downlink frame j to the UE, and records transmission time as t₂.
d) UE receives downlink frame j and records the time of arrival of the first detected path as t₄.
e) The following calculations are performed in the UE and gNB, respectively:
   i) UE_{Rx-Tx} diff=t₄-t₁
   ii) gNB_{Rx-Tx} diff=t₃-t₂. This quantity can be positive or negative depending on the whether gNB transmits the DL frame before or after receiving the UL frame.
f) Propagation delay can be calculated as follows: RTT=(gNB Rx−Tx time difference)+(UE Rx−Tx time difference). The propagation delay is one half of the RTT.

There are two variants of the method, depending on which node calculates the RTT and the other node delivers its Rx-TX difference.
1. UE-side propagation delay compensation (PDC): The gNB delivers the gNB Rx−Tx time difference to the UE and the UE calculates the round-trip time.
2. gNB-side PDC: The UE delivers the UE Rx−Tx time difference to the gNB and the gNB calculates the round-trip time.

When considering the legacy multi-RTT positioning method, preserving the orthogonality in UL transmissions from multiple UEs requires that they be time aligned at the gNB, i.e. they should reach the gNB around the same time (or within a certain time window such as, for example, within the cyclic prefix (CP) of the UL signal). Since UEs may be located at different distances from the gNBs, the UEs will need to initiate their UL transmissions at different times. A UE far from the gNB needs to start a transmission earlier than a UE close to the gNB. This can, for example, be handled by TA of the UL transmissions. Specifically, a UE starts its UL transmission before a nominal time given by the timing of the DL signal received by the UE.

Time alignment is ensured by network indicating a TA value to the UE. That value can be updated by the network, for example, as the UE moves closer or further away from the gNB. The Timing Advance Command field indicates the index value T_{A} used to control the amount of timing adjustment. A timing advance command in case of random access response or in an absolute timing advance command MAC CE, T_{A}, for a TAG indicates N_{TA} values by index values of T_{A}=0, 1, 2, . . . , 3846, where an amount of the time alignment for the TAG with Subcarrier Spacing (SCS) of 2^{μ}·15 KHZ is N_{TA}=T_{A}·16·64/2^{μ} N_{TA} is expressed in time units (e.g., in Tc where 1 Tc>>0.51 ns (basic time unit in NR, specified in 3GPP TS 38.211 v16.6.0)) and is relative to the SCS of the first UL transmission from the UE after the reception of the random access response (RAR) or absolute timing advance command MAC CE. Where μ=0, 1, 2, 3 and 4 corresponds to SCS=15 kHz, 30 kHz, 60 kHz, 120 kHz, 240 kHz, respectively.

In other cases, a timing advance command, A, for a Timing Advance Group (TAG) indicates adjustment of a current N_{TA} value, N_{TA_old}, to the new N_{TA} value, N_{TA_new}, by index values of T_{A}=0, 1, 2, . . . , 63, where for a SCS of 2^{μ}·15 kHz, N_{TA_new}=N_{TA_old}+(T_{A}−31)·16·64/2^{μ}.

There currently exist certain challenge(s). For example, in the NR Rel-16, the indicated time from the IE referenceTimeInfo indicates a time that is referenced at the network and without compensating for Radio Frequency (RF) propagation delay.

In the NR Rel-17 discussion, the following is agreed in the 3GPP RAN2 #115 meeting:
1. RAN2 assumes that gNB can perform pre-compensation. RAN2 agrees to introduce signalling to enable/disable UE-side PDC.
2. The gNB can enable/disable UE-side PDC via unicast-RRC signalling for Rel-17.

To enable UE-side PDC via unicast-RRC signalling introduces signalling overhead and also consumes computation power and energy consumption at the UE side. If the new RTT-based method for determining propagation delay is to be used, then it additionally requires the network to configure reference signals (e.g., PRS, Uplink Sounding reference signals (UL-SRS), etc.) and requires the network to calculate and deliver the gNB Rx−Tx time difference. In other words, it is beneficial, from the system point of view, to have as few UE-specific PDCs as possible.

In one example, the network can broadcast pre-compensated reference time information. Suppose the synchronization error/inaccuracy budget allocated to propagation delay for all UEs in the cell is ±X nanoseconds, in which a propagation time of a radio wave covering roughly one third of the radius of the cell size (denoted as R) is X nanoseconds.

An uncompensated reference time information from the gNB means that only those UEs, whose distance to the gNB is [0, R/3], do not require PDC. A smart gNB implementation would broadcast a pre-compensated reference time information with X nanoseconds (i.e., the indicated time in the SIB9 message is X nanoseconds before the actual internal gNB clock time). In such a way, those UEs, whose distance to the gNB is [0, 2*R/3], do not require PDC. The signalling overhead for per-UE PDC is reduced by half.

However, the broadcasted and pre-compensated reference time information can be read by all UEs in the cell. For those UEs that require per-UE PDC (i.e., UEs at a distance>2*R/3), it is, thus, unclear how to support the PDC since the existing methods (i.e., TA-based and RTT-based) are designed under the assumption that the reference time is un-compensated.

### SUMMARY

Certain aspects of the disclosure and their embodiments may provide solutions to these or other challenges. For example, according to certain embodiments, methods and systems are provided that introduce a new field as a supplement to the legacy reference time information provided by the referenceTimeInfo IE of SIB9. The new field is used to indicate the pre-compensated amount of time that has been applied to the indicated reference time and may be transmitted in a RRC-broadcast message, in a particular embodiment.

According to certain embodiments, a method by a UE for receiving reference time information includes receiving, from a network node, a dedicated message comprising first reference time information. The UE receives an indication to acquire an alternative reference time information to the first reference time information in the dedicated message and applies a second reference time information received in a broadcast message.

According to certain embodiments, a UE for receiving reference time information is adapted to receive, from a network node, a dedicated message comprising first reference time information. The UE is adapted to receive an indication to acquire an alternative reference time information to the first reference time information in the dedicated message. The UE is adapted to apply a second reference time information received in a broadcast message.

According to certain embodiments, a method by a network node for transmitting reference time information includes transmitting, to a UE, a dedicated message comprising first reference time information. The network node transmits, to the UE, an indication to acquire an alternative reference time information to the first reference time information in the dedicated message. The indication triggers the UE to apply second reference time information received in a broadcast message.

According to certain embodiments, a network node for transmitting reference time information is adapted to transmit, to a UE, a dedicated message comprising first reference time information. The network node is adapted transmit, to the UE, an indication to acquire an alternative reference time information to the first reference time information in the dedicated message. The indication triggers the UE to apply second reference time information received in a broadcast message.

Certain embodiments may provide one or more of the following technical advantage(s). For example, certain embodiments may provide a technical advantage of enabling the gNB to broadcast a pre-compensated reference time information to all UEs. At the same time, the gNB can indicate the need of the PDC to a subset of UEs (i.e., the set of UEs it determines to be at a distance too large for the pre-compensated reference time to be applied) and those UEs can perform RRC unicast signaling that allows them to determine the propagation delay and correctly compensate the uncompensated reference time according to the determined propagation delay.

As another example, certain embodiments may provide a technical advantage of requiring a fewer number of UEs per-UE PDC. Thus, certain embodiments may reduce the signalling overhead and the implementation complexity at the gNB. The amount of UEs that require per-UE PDC is determined based on UE distribution pattern within a given cell and the target distance selected for using pre-compensation (i.e. all UEs at or closer than twice the target distance can operate using pre-compensation).

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates gNB SFN transmissions;

FIG. 2 illustrates RTT-based propagation delay compensation;

FIG. 3 illustrates gNB compensated time, UE reception time without UE-side PDC, and UE reception time with UE-side PDC, according to certain embodiments;

FIG. 4 illustrates an example communication system, according to certain embodiments;

FIG. 5 illustrates an example UE, according to certain embodiments;

FIG. 6 illustrates an example network node, according to certain embodiments;

FIG. 7 illustrates a block diagram of a host, according to certain embodiments;

FIG. 8 illustrates a virtualization environment in which functions implemented by some embodiments may be virtualized, according to certain embodiments;

FIG. 9 illustrates a host communicating via a network node with a UE over a partially wireless connection, according to certain embodiments;

FIG. 10 illustrates an example method by a UE for receiving reference time information, according to certain embodiments; and

FIG. 11 illustrates an example method by a network node for transmitting reference time information, according to certain embodiments.

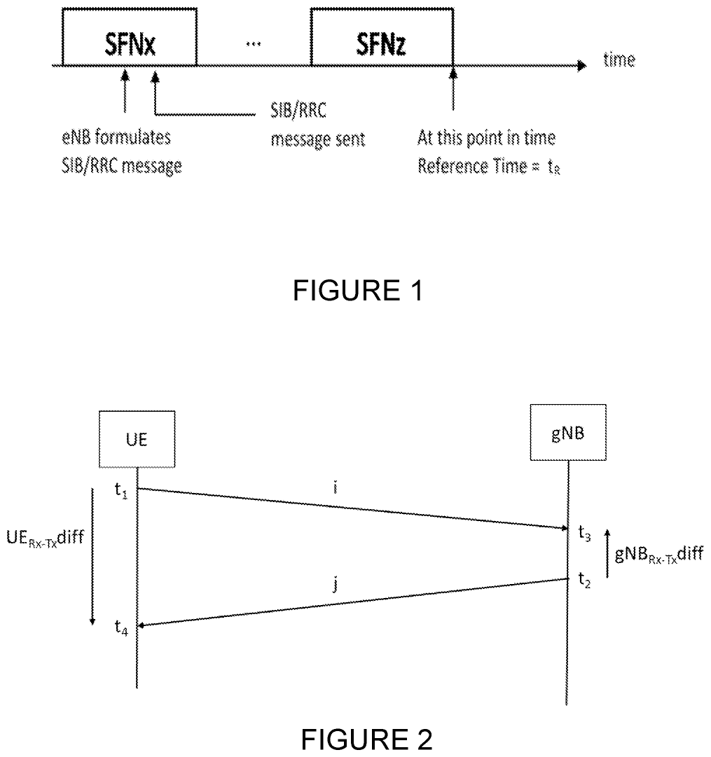

### DETAILED DESCRIPTION

Some of the embodiments contemplated herein will now be described more fully with reference to the accompanying drawings. Embodiments are provided by way of example to convey the scope of the subject matter to those skilled in the art.

According to certain embodiments, upon receiving an explicit indication or inferring from an implicit indication of the need for propagation delay compensation at the UE side, the UE acquires the uncompensated reference time information for propagation delay compensation, either by modifying the pre-compensated reference time to no longer reflect the pre-compensation amount of time or by directly receiving the uncompensated time in the RRC-unicast message (i.e. in the DLInformationTransfer message).

According to certain embodiments, a gNB uses SIB to broadcast the reference time information. The reference time information is pre-compensated to reflect a target distance (TD) from the gNB, and the SIB additionally indicates the pre-compensation amount as a separate broadcast parameter. In one example embodiment, the UE defaults to using the pre-compensated reference time information unless otherwise notified by the gNB. In a particular embodiment, the method includes:
gNB monitors the UL transmissions from the UE and thereby estimates the total applicable TA required at any point in time.
   If ½ the total TA required (i.e. the propagation delay) translates to a distance that is less than 2*TD, the UE defaults to delivering the received pre-compensated reference time to the upper layer.
   If ½ the total TA required (i.e. the propagation delay) translates to a distance that is greater than 2*TD, the gNB indicates to the UE (e.g. via RRC unicast signaling) that propagation delay compensation is needed and configures resources for estimating propagation delay compensation (if not already configured). Subsequently, the UE subtracts the pre-compensated amount (i.e., indicated by SIB) from the received pre-compensated reference time (to thereby acquire an uncompensated reference time), performs an RRC unicast procedure for estimating propagation delay and then adjusts the uncompensated reference time by the estimated propagation delay before delivering the adjusted reference time to the upper layer.
gNB continues to monitor the UL transmissions from the UE to determine the total TA required.
   If ½ the total TA (i.e. the propagation delay) continues to translate to a distance that is greater than 2*TD, the gNB and UE periodically perform the RRC unicast procedure for estimating propagation delay, and the UE adjusts the uncompensated reference time by the estimated propagation delay.
   Otherwise, if ½ the total TA required translates to a distance that is less than 2*TD the gNB informs the UE (e.g., via RRC unicast signaling) it is to revert to using the pre-compensated reference time (provided by SIB) which it then delivers to the upper layer.

In the above example embodiment, the UE defaults to using the pre-compensated reference time information unless otherwise notified by the gNB. In another embodiment, the UE applies the pre-compensated reference time information if UE-side PDC is disabled, and the UE applies both the pre-compensated reference time information and the pre-compensation amount if UE-side PDC is enabled. The disable/enable of UE-side PDC can be an explicit indication or an implicit indication (e.g., the lack of indication means that the UE does or does not apply UE-side PDC).

In some embodiments, the network indicates to the UE that the UE shall consider the time information sent from the network to the UE using dedicated signalling in an RRC unicast message as invalid.

### UE Methods and Solutions

In a particular embodiment, the RRC message containing the reference time information indicates that the time has been pre-compensated. In further particular embodiment, this RRC message indicates the amount of time that has been applied to pre-compensate the reference time. For example, if the pre-compensated gNB clock time is T (i.e., the pre-compensated reference time) and the uncompensated gNB clock time is t, then the applied compensation time information indicated by the message is T−t.

In a particular embodiment, a new information element ReferenceTimeInfoPreCompensation-v17xy can be added in the RRC spec that can be further included in the SIB9 or the DLInformationTransfer message. The field preCompensationTenNanoSeconds indicate the absolute value of T-t (which is typically a negative value) in a unit of ten nanoseconds.

| ReferenceTimeInfo-r16 ::= SEQUENCE { | |
|---|---|
| time-r16 | ReferenceTime-r16, |
| uncertainty-r16 | INTEGER (0..32767) |
| OPTIONAL, -- Need S | |
| timeInfoType-r16 | ENUMERATED {localClock} |
| OPTIONAL, -- Need S | |
| referenceSFN-r16 | INTEGER (0..1023) |
| OPTIONAL -- Cond RefTime | |
| } | |
| ReferenceTime-r16 ::= | SEQUENCE { |
| refDays-r16 | INTEGER (0..72999), |
| refSeconds-r16 | INTEGER (0..86399), |
| refMilliSeconds-r16 | INTEGER (0..999), |
| refTenNanoSeconds-r16 | INTEGER (0..99999) |

```
}
ReferenceTimeInfoPreCompensation-v17xy ::= SEQUENCE {
  preCompensated ENUMERATED {true} OPTIONAL,
  preCompensationTenNanoSeconds INTEGER (0..99999)
OPTIONAL
}
```

In further particular embodiment, the IE ReferenceTimeInfoPreCompensation-v17xy is only transmitted in a RRC broadcast message (e.g., SIB9). In some other variants, it can also be only transmitted in a RRC unicast message (e.g., DLInformationTransfer), or can be transmitted in both RRC-broadcast and RRC-unicast messages.

In a further particular embodiment, upon receiving a pre-compensation indication including that the time has been pre-compensated and the amount of the time that has been pre-compensated, the method includes:
1. If the UE is not requested to perform UE-side propagation delay compensation, which could either be that an explicit indication that UE-side propagation delay compensation is not needed or the lack of receiving an explicit indication that the UE-side propagation delay compensation is needed, then the UE delivers the reference time information to the upper layer without acting on the information contained in the IE ReferenceTimeInfoPreCompensation, i.e., regardless of whether the received reference time is pre-compensated and the amount of the pre-compensation.
2. If the UE is requested to perform UE-side propagation delay compensation, which could either be that an explicit indication that UE-side propagation delay compensation is needed or the lack of receiving an explicit indication that the UE-side propagation delay compensation is not needed, then the UE subtracts the amount of the pre-compensated time (e.g., indicated by the preCompensation TenNanoSeconds field in the IE ReferenceTimeInfoPreCompensation) in the Reference Time information that the UE receives in the broadcast message transmitted in the SIB9.

Below are two examples on how this can be implemented in the RRC specification, where changes to the specification are shown in bold and underline:
5.2.2.4.10 Actions upon reception of SIB9
Upon receiving SIB9 with referenceTimeInfo, the UE May
   1> if referenceTimeInfo is included:
      2>calculate the reference time based on the time and timeInfoType if it is included;
      2> If referenceTimeInfoPreCompensation is included; and
      2> If requested to perform UE-side propagation delay compensation
         3>subtract the time indicated in the preCompensationTenNanoSeconds field of the referenceTimeInfoPreCompensation IE from the reference time calculated using the ReferenceTime IE
      2>calculate the uncertainty of the reference time based on the uncertainty, if uncertainty is included;
      2>inform upper layers of the reference time and, if uncertainty is included, of the uncertainty.
5.7.1.3.x Actions upon indication of UE-side propagation delay compensation The UE shall:
   1>ACTIONS related with propagation delay calculation;
   1>Adjust the reference time in the DLnformationTransfer or SIB9 by the propagation delay;
   1> If referenceTimeInfoPreCompensation is included in the message for the last instance of the calculation of the reference time but not used in the calculation;
      2>subtract the time indicated in the preCompensationTenNanoSeconds field of the referenceTimeInfoPreCompensation IE from the reference time calculated using the ReferenceTime IE inform upper layers of the reference time

In another particular embodiment, if the UE also receives an RRC-unicast message containing the reference time information, the UE ignores the reference time information transmitted in the SIB9. In other words, if the UE receives both RRC-unicast message and RRC-broadcast message containing the reference time information, the reference time information in the RRC-unicast message takes precedence. For example, if the UE has received a reference time information in the SIB9 at time t₁ and just receives a reference time information in the DLInformationTransfer at time t₂>t₁, the UE ignores the reference time information received at t₁. On the other hand, if the UE receives another reference time information in the SIB9 at time t₃>t₂, the UE ignores this reference time information received at time t₃.

In further particular embodiment, the UE is configured with a validity timer for reference time information received in the DLInformationTransfer RRC message:
1. The timer is (re)-started upon reception of the RRC message DLInformationTransfer that contains the reference time information.
2. When the timer is running, the UE is not required to receive SIB9 message or ignores the reference time information received in the SIB9 message.
3. Upon expiry of the timer, the UE may start to decode the SIB9 and acquire the reference time information.

In another particular embodiment, the UE receives from the network an indication that indicates that the dedicated time information that the network has sent is invalid. The dedicated time information is sent in the RRC unicast message (e.g., DLInformationTransfer message). In the case the validity timer, as described in the previous embodiment, is configured and running, the timer is stopped or considered as expired. This may be implemented as the indication is triggering the stopping of (or triggers expiry of) the timer. The action of stopping or expiring the timer is, in turn, triggering the invalidation of the dedicated time information.

In a particular embodiment, the UE can in response to this (indication about invalidation of dedicated timing information) acquire broadcasted time information (e.g., transmitted in a RRC broadcast message in SIB9) and apply that information instead.

In a particular embodiment, even though the network has indicated to the UE that the dedicated time is not valid anymore, the UE may consider the previously received dedicated time information (which was indicated as invalid) to be valid for a certain time T after the network has indicated it to be invalid. This has the benefit that it allows the UE to acquire an alternative time information (e.g., via broadcast signalling). The time T may be defined as one or more of:
The time until the UE has acquired broadcast information;
A pre-configured time;
A time determined based on a validity time (as described above). For example, if the validity time is 3 seconds, the time T may be set to be k*3 where k may be a pre-configured value, or value specified in a specification;
A minimum or maximum of one or more of the above defined times.

If there is no broadcast time information available, the UE may determine that no timing information is applicable upon receiving the network indication that says that the dedicated time information is invalid.

### gNB Embodiments

In a particular embodiment, the gNB broadcasts the reference time information with a pre-compensated amount and this amount of time is transmitted in the broadcast messages (e.g., SIB9). The information can be sent in a new IE, e.g., ReferenceTimeInfoPreCompensation.

In further particular embodiment, the gNB monitors the UL transmission timing from the UE and keeps a record of the N_{TA} value of each UE. The propagation delay from the UE is roughly N_{TA}/2*Tc.

In another further particular embodiment, if gNB's knowledge of the calculated reference time information at the UE while UE has not applied UE-side PDC (i.e., calculated using the ReferenceTime IE with the pre-compensated reference time information (i.e., T) but not adjusted using the preCompensationTenNanoSeconds field of the referenceTimeInfoPreCompensation IE) is X nanoseconds away from the gNB clock time (reference time, i.e.,), while X is larger than the reference time delivery error budget for this UE, then the gNB triggers the use of per-UE propagation delay compensation, which includes:
1. Transmitting an indication to the UE to compensate the propagation delay.
2. In the case of RTT-based propagation delay compensation, the gNB configures the reference signals, transmits the DL reference signals, and receives the UL reference signals. Later, the gNB transmits the gNB Rx−Tx time to the UE.
3. Additionally, and independent from the above, the gNB transmits a RRC-unicast message that contains the reference time but the reference time is not pre-compensated, i.e., the time t. This is performed with the expectation that the UE would use this reference time for the propagation delay compensation without any further compensation.

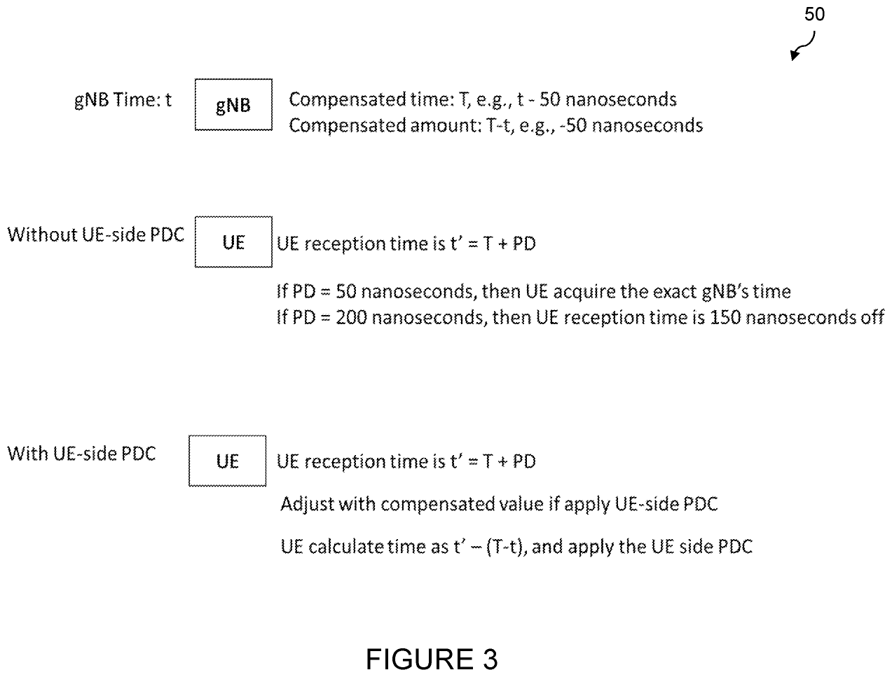

FIG. 3 illustrates an example 50 that includes gNB compensated time, UE reception time without UE-side PDC, and UE reception time with UE-side PDC, according to certain embodiments.

The gNB's knowledge of the calculated reference time information at the UE is computed as that:
Reference Time (compensated, i.e., T)+propagation delay

In another particular embodiment, if gNB's knowledge of the calculated reference time information at the UE while UE has not applied UE-side PDC (i.e., calculated using the ReferenceTime IE with the pre-compensated reference time information (i.e., T) but not adjusted using the preCompensationTenNanoSeconds field of the referenceTimeInfoPreCompensation IE) is X nanoseconds away from the gNB clock time (reference time, i.e., t), while X is smaller than the reference time delivery error budget for this UE, then the gNB triggers the disabling of the per-UE propagation delay compensation, which includes that:
1. Transmitting an indication to the UE to not to compensate the propagation delay.
2. In the case of RTT-based propagation delay compensation, the gNB de-configures the reference signals.
3. Additionally, and independent from the above, the gNB stop transmitting a RRC-unicast message that contains the reference time.

In a particular embodiment, the network may determine, for a particular UE, that the network no longer should provide time information by means of dedicated signalling (e.g., transmitted in the RRC message DLInformationTransfer). The network may, in response to this trigger, send an indication to the UE which indicates that the UE no longer shall apply timing received with dedicated signalling.

As described above with regard to the UE embodiments, the UE may consider previously received dedicated time information as still valid for a certain time T after the network has indicated the UE to stop applying the dedicated time information. This time T may be indicated from the network. The network may set this time depending on the periodicity of the broadcasted time information, e.g. set the time T to be the periodicity of the broadcasted time information.

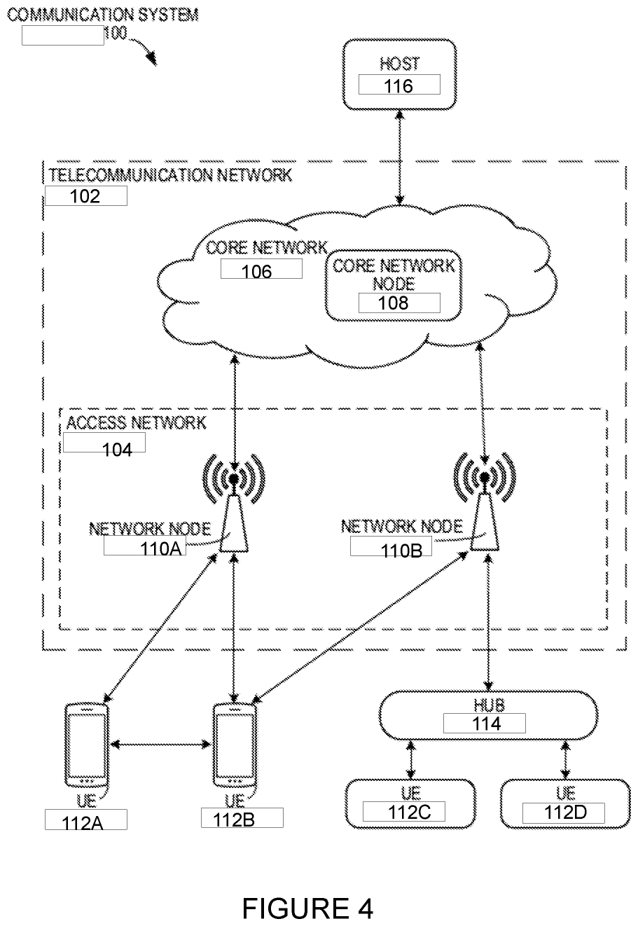

FIG. 4 shows an example of a communication system 100 in accordance with some embodiments.

In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

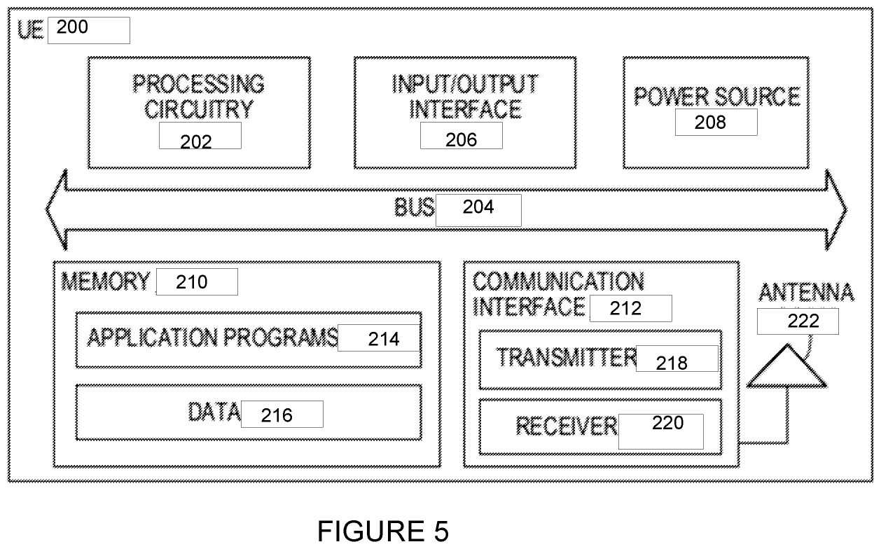

FIG. 5 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 5.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

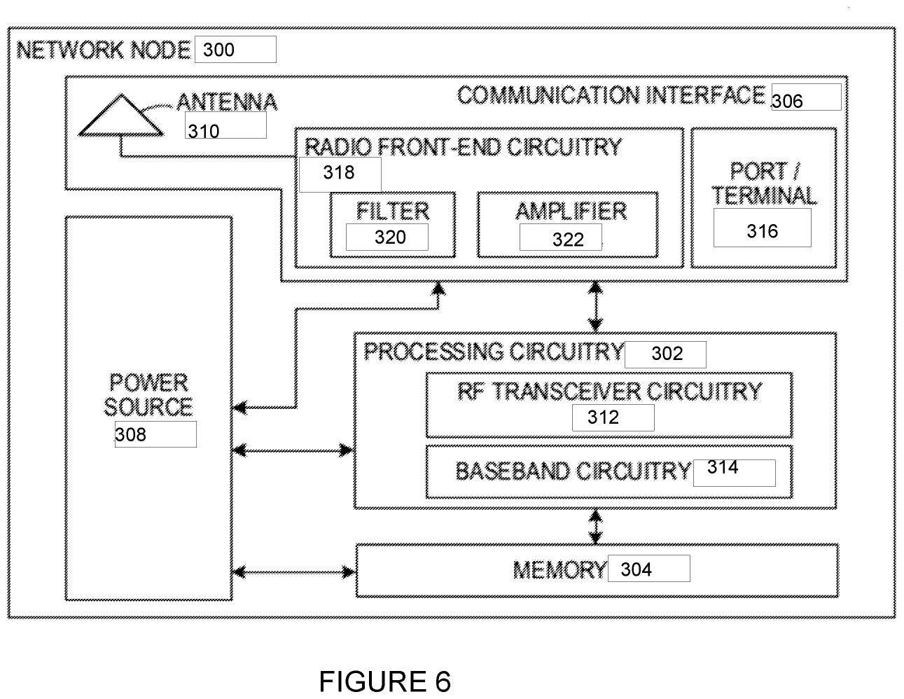

FIG. 6 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 6 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

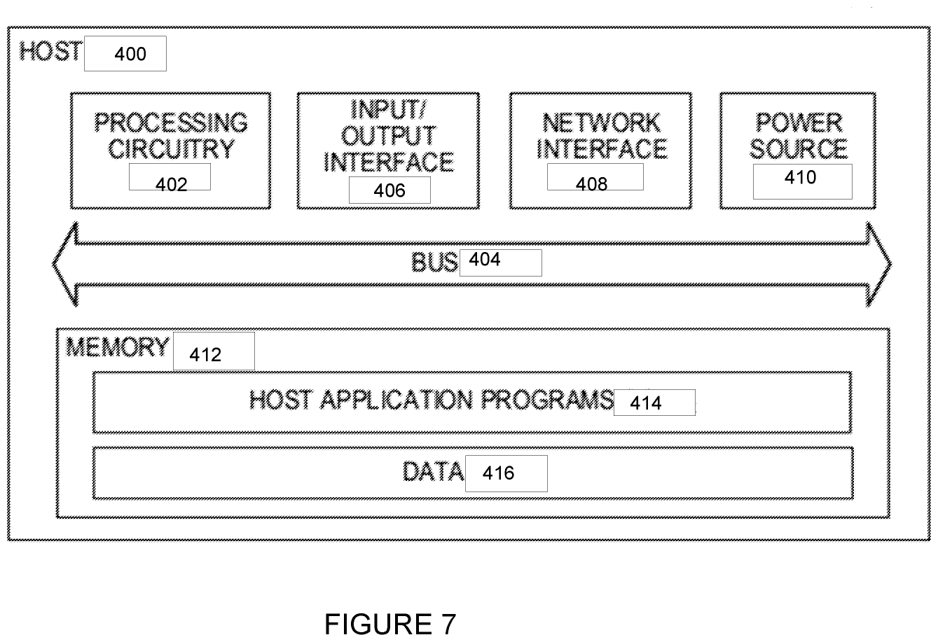

FIG. 7 is a block diagram of a host 400, which may be an embodiment of the host 116 of FIG. 4, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

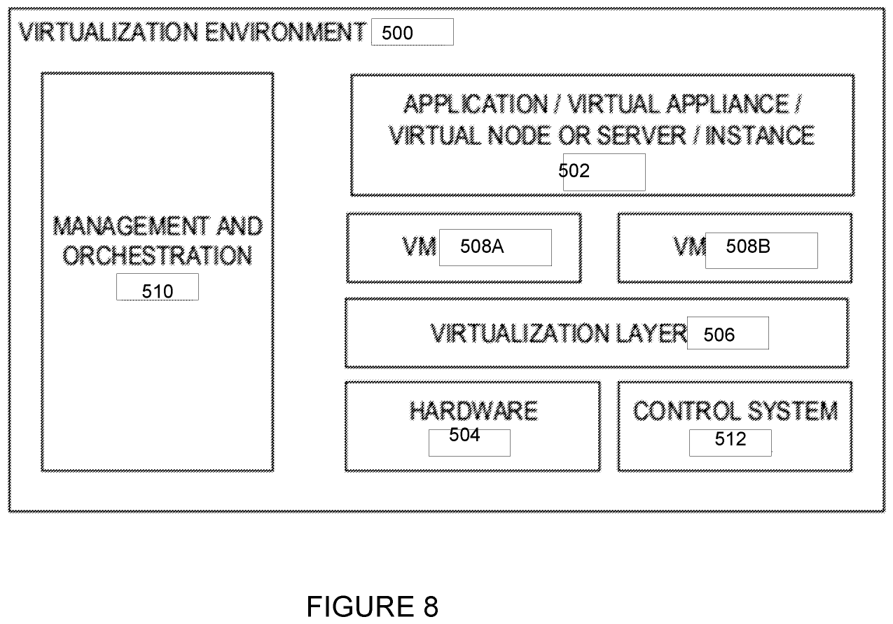

FIG. 8 is a block diagram illustrating a virtualization environment 500 in which functions implemented by some embodiments may be virtualized.

In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

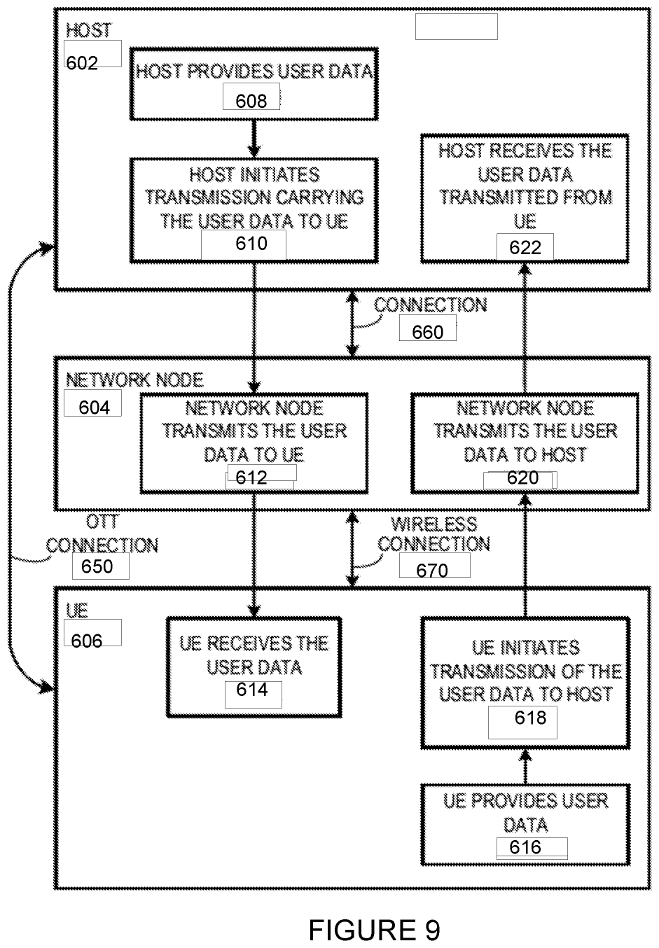

FIG. 9 shows a communication diagram of a host 602 communicating via a network node 604 with a UE 606 over a partially wireless connection in accordance with some embodiments.

Example implementations, in accordance with various embodiments, of the UE (such as a UE 112a of FIG. 4 and/or UE 200 of FIG. 5), network node (such as network node 110a of FIG. 4 and/or network node 300 of FIG. 6), and host (such as host 116 of FIG. 4 and/or host 400 of FIG. 7) discussed in the preceding paragraphs will now be described with reference to FIG. 9.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 4) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

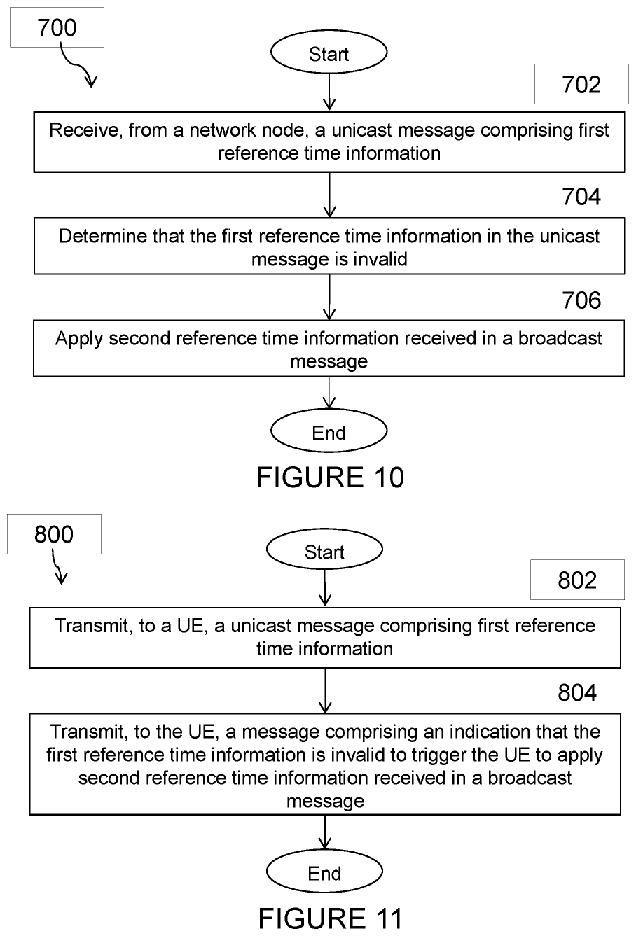

FIG. 10 illustrates a method 700 by a UE 112 for receiving reference time information, according to certain embodiments. The method begins at step 702 when the UE 112 receives, from a network node 110, a dedicated message comprising first reference time information. At step 704, the UE receives a first indication to acquire an alternative reference time information to the first reference time information in the dedicated message. At step 706, the UE applies a second reference time information received in a broadcast message. In a particular embodiment, the first indication to acquire the alternative reference time information is an indication that the first reference time information is invalid.

In a particular embodiment, the first indication comprises a SIB9 fallback indication, and the broadcast message comprising the second reference time information comprises a SIB9 message.

In a particular embodiment, the UE 112 considers the first reference time information as valid for at least a time period, T, after the UE receives the first indication to acquire the alternative reference time information. The UE 112 uses the first reference time information during the time period, T, and ceases to use the first reference time information after the time period, T, has expired.

In a particular embodiment, applying the second reference time information is based on receiving the first indication to acquire an alternative reference time information.

In a particular embodiment, prior to receiving the first indication to acquire an alternative reference time information, the UE 112 applies the first reference time information.

In a particular embodiment, the UE 112 applies a third reference time information that is received in a second dedicated message instead of the second reference time information.

In a particular embodiment, the UE 112 receives the broadcast message comprising the second reference time information.

In a particular embodiment, the broadcast message comprises an indication of an amount of time that has been applied to pre-compensate the second reference time information.

In a particular embodiment, the second reference time information is associated with a propagation delay compensation to reflect a target distance, TD, from the network node.

In a particular embodiment, the UE 112 determines whether the UE is to perform UE-side propagation delay compensation. If the UE determines that the UE is to perform UE-side propagation delay compensation, the UE 112 performs UE-side propagation delay compensation before transmitting, to the upper layer, a reference time that is calculated based on the second reference time information. Alternatively, if the UE determines that the UE is not to perform UE-side propagation delay compensation, the UE 112 transmits, to the upper layer, a reference time that is calculated based on the second reference time information without performing UE-side propagation delay compensation.

In a particular embodiment, performing UE-side propagation delay compensation includes subtracting an amount of pre-compensated time from the second reference time information.

In a particular embodiment, the UE 112 receives, from the network node 110, a second indication, which triggers the use of per-UE propagation delay compensation by the UE 112 when the reference time that is calculated without adjustment is X time away from a clock time maintained by the network node, wherein X is larger than a reference time delivery error budget.

In a particular embodiment, the UE 112 receives, from the network node 110, a third indication, which triggers disabling of per-UE propagation delay compensation at the UE 112 when the reference time that is calculated without adjustment is X time away from a clock time maintained by the network node, wherein X is smaller than a reference time delivery error budget.

In a particular embodiment, the first indication to acquire the alternative reference time information comprises a validity timer and the UE applies a second reference time information based on expiration of the timer.

FIG. 11 illustrates a method 800 by a network node 110 for transmitting reference time information, according to certain embodiments. The method begins at step 802 when the network node 110 transmits, to a UE, a dedicated message comprising first reference time information. At step 804, the network node 110 transmits, to the UE 112, a first indication to acquire an alternative reference time information to the first reference time information in the dedicated message. The first indication triggers the UE to apply a second reference time information received in a broadcast message.

In a particular embodiment, the network node 110 determines that the first reference time information is invalid for the UE, and the first indication is transmitted to the UE 112 based on determining that the first reference time information is invalid.

In a particular embodiment, the indication comprises a SIB9 fallback indication, and the broadcast message comprising the second reference time information comprises a SIB9 message.

In a particular embodiment, the network node 110 configures the UE 112 to use the first reference time information during a time period, T, after the network node transmits the first indication and/or after the UE receives the first indication. The network node 110 also configures the UE 112 to cease using the first reference time information after the time period, T, has expired.

In a particular embodiment, the network node 110 transmits, to the UE 112, a third reference time information in a second dedicated message to trigger the UE 112 to apply the third reference time information instead of the second reference time information.

In a particular embodiment, the network node 110 transmits, to the UE 112, the broadcast message comprising the second reference time information.

In a particular embodiment, the broadcast message comprises an indication of an amount of time that has been applied to pre-compensate the second reference time information.

In a particular embodiment, the second reference time information is associated with a propagation delay compensation to reflect a TD from the network node to the UE.

In a particular embodiment, the network node 110 monitors a timing of an uplink transmission timing from the UE 112 and estimates, for at least one uplink transmission, a total applicable TA required at any point in time.

In a particular embodiment, the network node 110 determines that ½ the total applicable TA translates to a distance that is less than 2*TD, and indicates, to the UE 112, to use the second reference time information that has been pre-compensated.

In a particular embodiment, the network node 110 determines that ½ the total applicable TA translates to a distance that is greater than 2*TD, and indicates, to the UE 112, that propagation delay compensation is needed, and configures at least one resource for estimating propagation delay compensation.

In a particular embodiment, the network node 110 transmits a second indication to the UE 112, which triggers the use of per-UE propagation delay compensation by the UE 110 when the reference time that is calculated without adjustment is X time away from a clock time maintained by the network node 110, wherein X is larger than a reference time delivery error budget. In some examples, the reference time that is calculated is a reference time maintained at the UE.

In a particular embodiment, the network node 110 transmits a third indication to the UE 112 to trigger the disabling of per-UE propagation delay compensation at the UE 112 when the reference time that is calculated without adjustment is X time away from a clock time maintained by the network node, wherein X is smaller than a reference time delivery error budget. In some examples, the reference time that is calculated is a reference time maintained at the UE.

In a particular embodiment, the network node 110 monitors a timer and determines that the first reference time information is invalid is based on an expiration of the timer.

### Example Embodiments

### Group A Example Embodiments

Example Embodiment A1. A method by a user equipment for indication of propagation delay compensation, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for indication of propagation delay compensation, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) for indication of propagation delay compensation, the method comprising: receiving, from a network node, a message comprising an indication that reference time information has been pre-compensated.

Example Embodiment C2. The method of Example Embodiment C1, wherein the message comprises the reference time information.

Example Embodiment C3. The method of any one of Example Embodiments C1 to C2, wherein the message comprises a RRC message.

Example Embodiment C4. The method of any one of Example Embodiments C1 to C3, wherein the message comprises an indication of an amount of time that has been applied to pre-compensate the reference time to reflect a target distance from the gNB.

Example Embodiment C5. The method of any one of Example Embodiments C1 to C4, wherein the reference time information is associated with the propagation delay.

Example Embodiment C6. The method of any one of Example Embodiments C1 to C5, wherein the message comprises a broadcast message such as, for example, a SIB.

Example Embodiment C7. The method of any one of Example Embodiments C1 to C6, further comprising: determining whether the UE is to perform UE-side propagation delay compensation, and if the UE determines that the UE is to perform UE-side propagation delay compensation, performing UE-side propagation delay compensation before transmitting reference time information to the network node, or if the UE determines that the UE is not to perform UE-side propagation delay compensation, transmitting, to the network node, reference time information without performing UE-side propagation delay compensation.

Example Embodiment C8. The method of Example Embodiment C7, wherein performing UE-side propagation delay compensation comprises subtracting an amount of pre-compensated time from a reference time calculated by the UE.

Example Embodiment C9. The method of any one of Example Embodiments C1 to C8, further comprising: transmitting, to the network node, information of a calculated reference time at the UE while the UE has not applied UE-side PDC without adjustment, and receiving, from the network node, an indication triggering the use of per-UE propagation delay compensation by the UE when the calculated reference time without adjustment is X time away from a clock time maintained by the network node, wherein X is larger than a reference time delivery error budget.

Example Embodiment C10. The method of any one of Example Embodiments C1 to C8, further comprising: transmitting, to the network node, information of a calculated reference time at the UE while the UE has not applied UE-side PDC without adjustment, and receiving, from the network node, an indication triggering disabling of per-UE propagation delay compensation at the UE when the calculated reference time without adjustment is X time away from a clock time maintained by the network node, wherein X is smaller than a reference time delivery error budget.

Example Embodiment C11. The method of any one of Example Embodiments C1 to C10, wherein the UE is configured to use the reference time information that has been pre-compensated as a default.

Example Embodiment C12. The method of any one of Example Embodiments C1 to C11, wherein the UE is configured to use the reference time information that has been pre-compensated when UE-side PDC is disabled.

Example Embodiment C13. The method of any one of Example Embodiments C1 to C12, wherein the UE is configured to use both the reference time information that has been disabled and a pre-compensation amount when UE-side PDC is enabled.

Example Embodiment C14. The method of any one of Example Embodiments C12 to C13, further comprising receiving, from the network node, a signal indicating whether UE-side PDC is enabled or disabled.

Example Embodiment C15. The method of any one of Example Embodiments C1 to C14, further comprising determining that the reference time information is invalid.

Example Embodiment C16. The method of Example Embodiment C15, further comprising receiving, from the network node, a message comprising an indication that the reference time information is invalid.

Example Embodiment C17. The method of Example Embodiment C16, wherein the message is received via a Radio Resource Control unicast message.

Example Embodiment C18. The method of any one of Example Embodiments C16 to C17, wherein the UE considers the reference time information as valid for at least a time period, T, after the UE receives the message comprising the indication that the reference time information is invalid.

Example Embodiment C19. The method of Example Embodiment C18, further comprising using the reference time information during the time period, T, and ceasing to use the reference time information after the time period, T, has expired.

Example Emboidment C20. The method of any one of Example Embodiments C18 to C19, wherein the time period, T, comprises at least one of: (a) an amount of time until the UE has acquired additional time information, (b) a pre-configured amount of time; (c) an amount of time determined based on a validity time; and (d) a minimum or maximum of any one of (a) through (c) above.

Example Embodiment C21. The method of any one of Example Embodiments D19 to D20, further comprising receiving, from the network node, a message indicating the time period, T.

Example Embodiment C22. The method of any one of Example Embodiments C15 to C21, further comprising stopping a timer based on determining that the reference time information is valid and/or receiving the message comprising the indication that the reference time information is invalid.

Example Embodiment C23. The method of any one of Example Embodiments C15 to C22, further comprising invalidating the reference time information based on determining that the reference time information is valid and/or receiving the message comprising the indication that the reference time information is invalid.

Example Embodiment C24. The method of any one of Example Embodiments C21 to C23, further comprising receiving, via broadcast, additional time information and applying the additional time information instead of the reference time information.

Example Embodiment C25. The method of any one of Example Embodiments C15 to C23, further comprising determining that no timing information is applicable after receiving the message indicating that the reference time information is invalid.

Example Embodiment C26. The method of Example Embodiments C1 to C25, further comprising: providing user data; and forwarding the user data to a host via the transmission to the network node.

Example Embodiment C27.A user equipment comprising processing circuitry configured to perform any of the methods of Example Embodiments C1 to C26.

Example Embodiment C28. A UE comprising processing circuitry configured to perform any of the methods of Example Embodiments C1 to C26.

Example Embodiment C29. A computer program comprising instructions which when executed on a computer perform any of the methods of Example Embodiments C1 to C26.

Example Embodiment C30. A computer program product comprising computer program, the computer program comprising instructions which when executed on a computer perform any of the methods of Example Embodiments C1 to C26.

Example Embodiment C31.A non-transitory computer readable medium storing instructions which when executed by a computer perform any of the methods of Example Embodiments C1 to C26.

### Group D Example Embodiments

Example Embodiment D1. A method by a network node for indication of propagation delay compensation, the method comprising: transmitting, to a user equipment (UE), a message comprising an indication that reference time information has been pre-compensated.

Example Embodiment D2. The method of Example Embodiment D1, wherein the message comprises the reference time information.

Example Embodiment D3. The method of any one of Example Embodiments D1 to D2, wherein the message comprises a RRC message.

Example Embodiment D4. The method of any one of Example Embodiments D1 to D3, wherein the message comprises an indication of an amount of time that has been applied to pre-compensate the reference time to reflect a target distance from the gNB.

Example Embodiment D5. The method of any one of Example Embodiments D1 to D4, wherein the reference time information is associated with the propagation delay.

Example Embodiment D6. The method of any one of Example Embodiments D1 to D5, wherein the message comprises a broadcast message such as, for example, a SIB.

Example Embodiment D7. The method of any one of Example Embodiments D1 to D6, further comprising: monitoring an uplink transmission timing from the UE; and based on the uplink transmission timing, determining an amount of time to apply to pre-compensate the reference time information based on the uplink transmission timing.

Example Embodiment D8. The method of Example Embodiment D7, wherein monitoring the uplink transmission timing comprises estimating, for at least one uplink transmission, a total applicable TA required at any point in time.

Example Embodiment D9. The method of Example Embodiment D8, further comprising: determining that ½ the total applicable TA translates to a distance that is less than 2*TD, and indicating, to the UE, to default to using the reference time information that has been pre-compensated.

Example Embodiment D10. The method of Example Embodiment D8, further comprising: determining that ½ the total applicable TA translates to a distance that is greater than 2*TD, and indicating, to the UE, that propagation delay compensation is needed, and optionally, configuring at least one resource for estimating propagation delay compensation.

Example Embodiment D11. The method of any one of Example Embodiments D1 to D10, further comprising: obtaining information of a calculated reference time at the UE while the UE has not applied UE-side PDC without adjustment, and determining that the calculated reference time without adjustment is X time away from a clock time maintained by the network node, wherein X is larger than a reference time delivery error budget; and transmitting an indication to the UE to trigger the use of per-UE propagation delay compensation.

Example Embodiment D12. The method of any one of Example Embodiments D1 to D10, further comprising: obtaining information of a calculated reference time at the UE while the UE has not applied UE-side PDC without adjustment, and determining that the calculated reference time without adjustment is X time away from a clock time maintained by the network node, wherein X is smaller than a reference time delivery error budget; and transmitting an indication to the UE to trigger the disabling of per-UE propagation delay compensation.

Example Embodiment D13. The method of any one of Example Embodiments D1 to D12, further comprising configuring the UE to use the reference time information that has been pre-compensated as a default.

Example Embodiment D14. The method of any one of Example Embodiments D1 to D12, further comprising configuring the UE to use the reference time information that has been pre-compensated when UE-side PDC is disabled.

Example Embodiment D15. The method of any one of Example Embodiments D1 to D14, further comprising configuring the UE to use both the reference time information that has been disabled and a pre-compensation amount when UE-side PDC is enabled.

Example Embodiment D16. The method of any one of Example Embodiments D14 to D15, further comprising transmitting a signal to the UE indicating whether UE-side PDC is enabled or disabled.

Example Embodiment D17. The method of any one of Example Embodiments D1 to D16, further comprising determining that the reference time information is invalid for the UE.

Example Embodiment D18. The method of Example Embodiment D17, further comprising transmitting, to the UE, a message comprising an indication that the reference time information is invalid.

Example Embodiment D19. The method of Example Embodiment D18, wherein the message is transmitted via a Radio Resource Control unicast message.

Example Embodiment D20. The method of any one of Example Embodiments D17 to D29, wherein the reference time information is valid for at least a time period, T, after the network node transmits the message and/or after the UE receives the message comprising the indication that the reference time information is invalid.

Example Embodiment D21. The method of Example Embodiment D20, further comprising configuring the UE to use the reference time information during the time period, T, and configuring the UE to cease using the reference time information after the time period, T, has expired.

Example Emboidment D22. The method of any one of Example Embodiments D20 to D21, wherein the time period, T, comprises at least one of: (a) an amount of time until the UE has acquired additional time information, (b) a pre-configured amount of time; (c) an amount of time determined based on a validity time; and (d) a minimum or maximum of any one of (a) through (c) above.

Example Embodiment D23. The method of any one of Example Embodiments D21 to D22, further comprising transmitting a message, to the UE, indicating the time period, T.

Example Embodiment D24. The method of any one of Example Embodiments D16 to D23, further comprising at least one of: stopping a timer at the network node based on the reference time information being invalid for the UE, and configuring the UE to stop a timer at the UE based on determining and/or receiving the message comprising the indication that the reference time information is invalid.

Example Embodiment D25. The method of any one of Example Embodiments D16 to D24, further comprising transmitting, via broadcast, additional time information to the UE, and wherein the UE is configured to apply the additional time information instead of the reference time information after receiving the message comprising the indication that the reference time information is invalid.

Example Embodiment D26. The method of any one of Example Embodiments D16 to D25, wherein no timing information is applicable after transmitting the message comprising the indication that the reference time information is invalid.

Example Embodiment D27. The method of any one of Example Embodiments D1 to D26, wherein the network node comprises a gNodeB (gNB).

Example Embodiment D28. The method of any of the previous Example Embodiments, further comprising: obtaining user data; and forwarding the user data to a host or a user equipment.

Example Embodiment D29. A network node comprising processing circuitry configured to perform any of the methods of Example Embodiments D1 to D28.

Example Embodiment D30. A computer program comprising instructions which when executed on a computer perform any of the methods of Example Embodiments D1 to D28.

Example Embodiment D31. A computer program product comprising computer program, the computer program comprising instructions which when executed on a computer perform any of the methods of Example Embodiments D1 to D28.

Example Embodiment D32. A non-transitory computer readable medium storing instructions which when executed by a computer perform any of the methods of Example Embodiments D1 to D28.

### Group E Example Embodiments

Example Embodiment E1. A user equipment for indication of propagation delay compensation, comprising: processing circuitry configured to perform any of the steps of any of the Group A and C Example Embodiments; and power supply circuitry configured to supply power to the processing circuitry.

Example Embodiment E2. A network node for indication of propagation delay compensation, the network node comprising: processing circuitry configured to perform any of the steps of any of the Group B and D Example Embodiments; power supply circuitry configured to supply power to the processing circuitry.

Example Embodiment E3. A user equipment (UE) for indication of propagation delay compensation, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Emboidment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1.-32. (canceled)

33. A method by a user equipment, UE, for receiving reference time information, the method comprising:
receiving, from a network node, a dedicated message comprising first reference time information;
receiving a first indication to acquire an alternative reference time information to the first reference time information in the dedicated message; and
applying a second reference time information received in a broadcast message.

34. The method of claim 33, wherein the first indication to acquire the alternative reference time information comprises an indication that the first reference time information is invalid.

35. The method of claim 34, wherein the first indication comprises a SIB9 fallback indication, and wherein the broadcast message comprising the second reference time information comprises a SIB9 message.

36. The method of claim 34, wherein the UE considers the first reference time information as valid for at least a time period, T, after the UE receives the first indication to acquire the alternative reference time information, and wherein the method further comprises:
using the first reference time information during the time period, T, and
ceasing to use the first reference time information after the time period, T, has expired.

37. The method of claim 33, wherein applying the second reference time information is based on receiving the first indication to acquire an alternative reference time information.

38. The method of claim 33, further comprising at least one of:
prior to receiving the first indication to acquire an alternative reference time information, applying the first reference time information;
applying a third reference time information that is received in a second dedicated message instead of the second reference time information; and
receiving the broadcast message comprising the second reference time information.

39. The method of claim 33, wherein the broadcast message comprises an indication of an amount of time that has been applied to pre-compensate the second reference time information, optionally wherein the second reference time information is associated with a propagation delay compensation to reflect a target distance, TD, from the network node.

40. The method of claim 33, further comprising:
determining whether the UE is to perform UE-side propagation delay compensation, and
if the UE determines that the UE is to perform UE-side propagation delay compensation, performing UE-side propagation delay compensation before transmitting, to the upper layer, a reference time that is calculated based on the second reference time information, or
if the UE determines that the UE is not to perform UE-side propagation delay compensation, transmitting, to the upper layer, a reference time that is calculated based on the second reference time information without performing UE-side propagation delay compensation, optionally wherein performing UE-side propagation delay compensation comprises subtracting an amount of pre-compensated time from the second reference time information.

41. The method of claim 33, further comprising at least one of:
receiving a second indication from the network node, the second indication triggering the use of per-UE propagation delay compensation by the UE when the reference time that is calculated without adjustment is X time away from a clock time maintained by the network node, wherein X is larger than a reference time delivery error budget; and
receiving a third indication from the network node, the third indication triggering disabling of per-UE propagation delay compensation at the UE when the reference time that is calculated without adjustment is X time away from a clock time maintained by the network node, wherein X is smaller than a reference time delivery error budget.

42. The method of claim 33, wherein the first indication to acquire the alternative reference time information comprises a validity timer and the UE applies a second reference time information based on expiration of the timer.

43. A method by a network node for transmitting reference time information, the method comprising:
transmitting, to a user equipment, UE, a dedicated message comprising first reference time information; and
transmitting, to the UE, a first indication to acquire an alternative reference time information to the first reference time information in the dedicated message, the first indication triggering the UE to apply second reference time information; and
transmitting a broadcast message comprising the second reference time information.

44. The method of claim 43, further comprising determining that the first reference time information is invalid for the UE, and wherein the first indication is transmitted to the UE based on determining that the first reference time information is invalid.

45. The method of claim 43, wherein the indication comprises a SIB9 fallback indication, and wherein the broadcast message comprising the second reference time information comprises a SIB9 message.

46. The method of claim 43, further comprising:
configuring the UE to use the first reference time information during a time period, T, after the network node transmits the first indication and/or after the UE receives the first indication; and
configuring the UE to cease using the first reference time information after the time period, T, has expired.

47. The method of claim 43, further comprising:
transmitting, to the UE, a third reference time information in a second dedicated message to trigger the UE to apply the third reference time information instead of the second reference time information.

48. The method of claim 43, wherein the broadcast message comprises an indication of an amount of time that has been applied to pre-compensate the second reference time information.

49. The method of claim 43, wherein the second reference time information is associated with a propagation delay compensation to reflect a target distance, TD, from the network node to the UE.

50. The method of claim 43, further comprising:
monitoring a timing of an uplink transmission timing from the UE; and
estimating, for at least one uplink transmission, a total applicable timing advance, TA, required at any point in time, optionally further comprising at least one of:
determining that ½ the total applicable TA translates to a distance that is less than 2*TD, and
indicating, to the UE, to use the second reference time information that has been pre-compensated; and
determining that ½ the total applicable TA translates to a distance that is greater than 2*TD, and
indicating, to the UE, that propagation delay compensation is needed, and
configuring at least one resource for estimating propagation delay compensation.

51. The method of claim 43, further comprising at least one of:
transmitting a second indication to the UE to trigger the use of per-UE propagation delay compensation by the UE when the reference time that is calculated without adjustment is X time away from a clock time maintained by the network node, wherein X is larger than a reference time delivery error budget; and
transmitting a third indication to the UE to trigger the disabling of per-UE propagation delay compensation at the UE when the reference time that is calculated without adjustment is X time away from a clock time maintained by the network node, wherein X is smaller than a reference time delivery error budget.

52. The method of claim 43, further comprising at least one of:
monitoring a timer, and
determining that the first reference time information is invalid based on an expiration of the timer.

53. A user equipment, UE, for receiving reference time information, the UE adapted to:
receive, from a network node, a dedicated message comprising first reference time information;
receive a first indication to acquire an alternative reference time information to the first reference time information in the dedicated message; and
apply a second reference time information received in a broadcast message.

54. A network node for transmitting reference time information, the network node adapted to:
transmit, to a user equipment, UE, a dedicated message comprising first reference time information; and
transmit, to the UE, a first indication to acquire an alternative reference time information to the first reference time information in the dedicated message, the indication triggering the UE to apply second reference time information; and
transmit a broadcast message comprising the second reference time information.
